(19) United States
(12) Patent Application Publication
(10) Pub. No.: US 2023/0300175 A1
(43) Pub. Date: Sep. 21, 2023

(54) NETWORK SECURITY

(71) Applicant: ARM LIMITED, Cambridge, Cambridgeshire (GB)

(72) Inventors: Gustavo Federico PETRI, Cambridge, Cambridgeshire (GB); Anthony Charles Joseph FOX, Cambridge, Cambridgeshire (GB); Basma EL GAABOURI, Cambridge, Cambridgeshire (GB)

(21) Appl. No.: 18/042,272

(22) PCT Filed: Aug. 6, 2021
(86) PCT No.: PCT/GB2021/052049

§ 371 Date: Feb. 20, 2023

(30) Foreign Application Priority Data
Aug. 25, 2020 (GB) 2013283.3

(51) Int. Cl. H04L 9/40

(52) U.S. Cl. CPC H04L 63/205

(57) ABSTRACT

There is provided a network node coordinator system. Communication circuitry communicates, via a network, with one or more network nodes. Receive circuitry receives a global policy that describes a security policy to be applied across the network. Policy processing circuitry specialises the global policy and produces, for each of the one or more network nodes, an associated local policy specific to that network node. Transmit circuitry transmits, to each of the one or more network nodes, the associated local policy specific to that network node.

The present technique relates to security, particularly in respect of computer networks.

Network security can be difficult to achieve - particularly in view of networks that are heterogeneous (e.g. having lots of different devices). This problem is exacerbated in situations where the network configuration changes over time. It is therefore desirable to provide a mechanism in which, regardless of changes to the network, and regardless of the heterogeneity of the network, a user is able to easily implement and update a desired security policy.

Viewed from a first example configuration, there is provided a network node coordinator system comprising: communication circuitry to communicate, via a network, with one or more network nodes; receive circuitry configured to receive a global policy that describes a security policy to be applied across the network; policy processing circuitry to specialise the global policy and to produce, for each of the one or more network nodes, an associated local policy specific to that network node; and transmit circuitry configured to transmit, to each of the one or more network nodes, the associated local policy specific to that network node.

Viewed from a second example configuration, there is provided a method comprising: communicating, via a network, with one or more network nodes; receiving a global policy that describes a security policy to be applied across the network; and specialising the global policy to produce, for each of the one or more network nodes, an associated local policy specific to that network node; and transmitting, to each of the one or more network nodes, the associated local policy specific to that network node.

Viewed from a third example configuration, there is provided a network node comprising: network interface circuitry configured to enable communication via a network; receive circuitry configured to receive a local policy from a network node coordinator system; barrier circuitry configured to restrict use of the network interface circuitry based on the local policy; and processing circuitry configured to provide one or more encapsulated execution environments, wherein network traffic from each of the one or more encapsulated execution environments is restricted to flowing via the barrier circuitry.

Viewed from a fourth example configuration, there is provided a method comprising: receiving a local policy from a network node coordinator system; providing a barrier that restricts use of network interface circuitry based on the local policy; and providing one or more encapsulated execution environments, wherein network traffic from each of the one or more encapsulated execution environments is restricted to flowing via the barrier.

The present technique will be described further, by way of example only, with reference to embodiments thereof as illustrated in the accompanying drawings, in which:

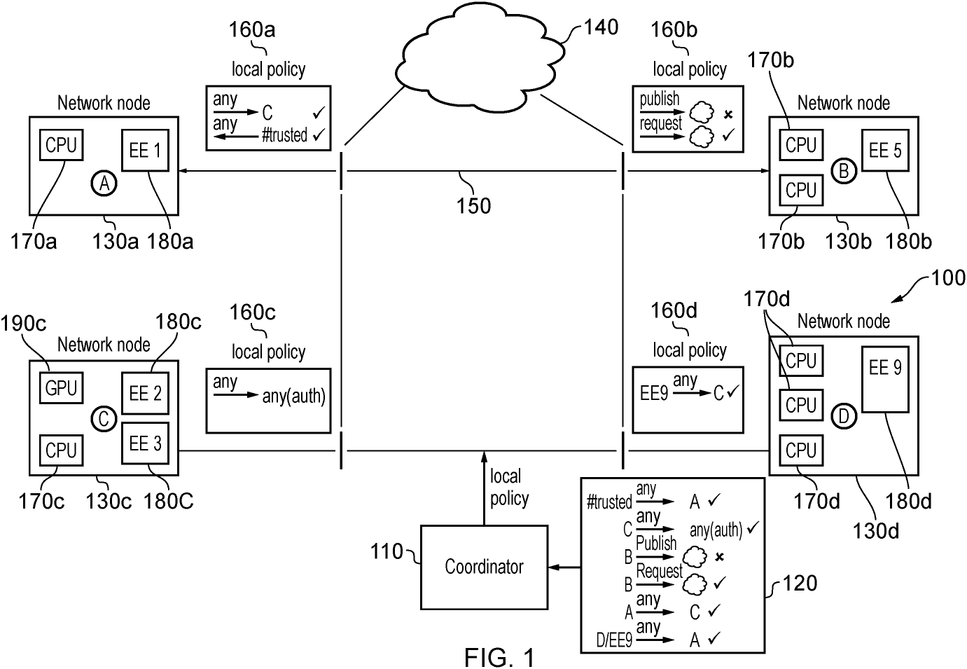

FIG. 1 illustrates a system containing a coordinator and a plurality of network nodes in accordance with some embodiments;

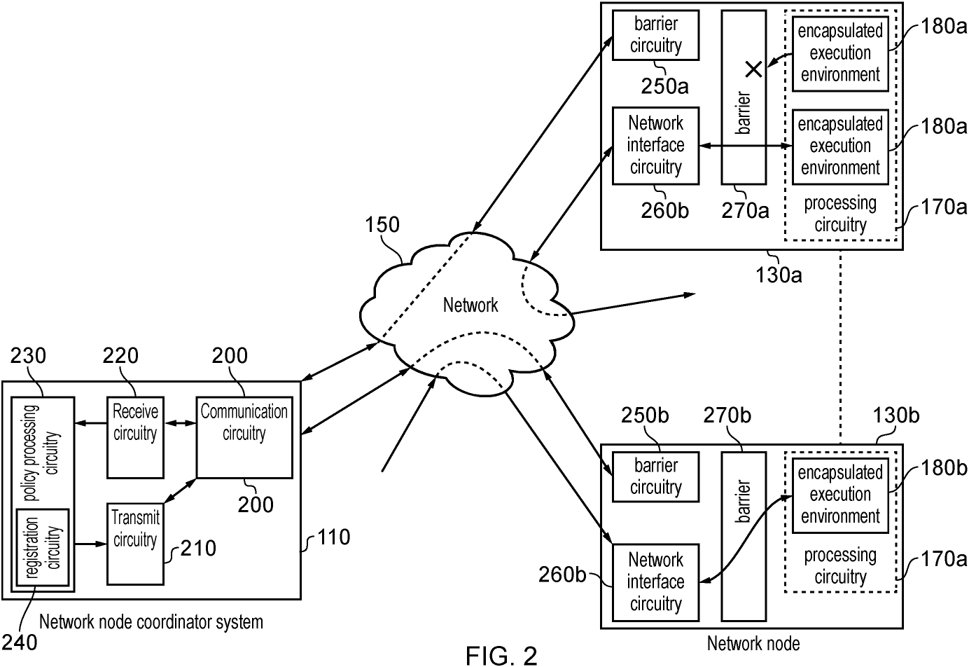

FIG. 2 illustrates the interaction between the coordinator and the network nodes in accordance with some embodiments;

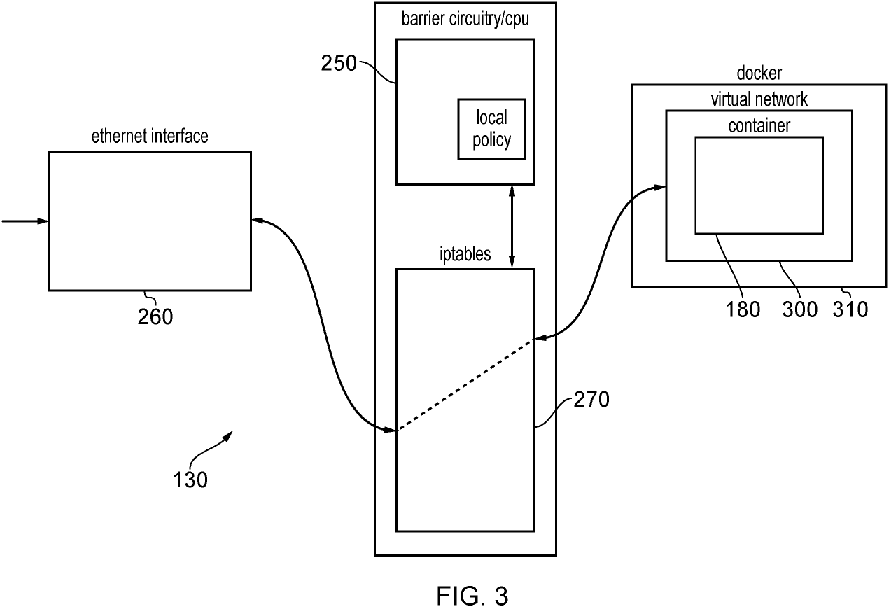

FIG. 3 schematically illustrates the configuration of an example network node in accordance with some embodiments;

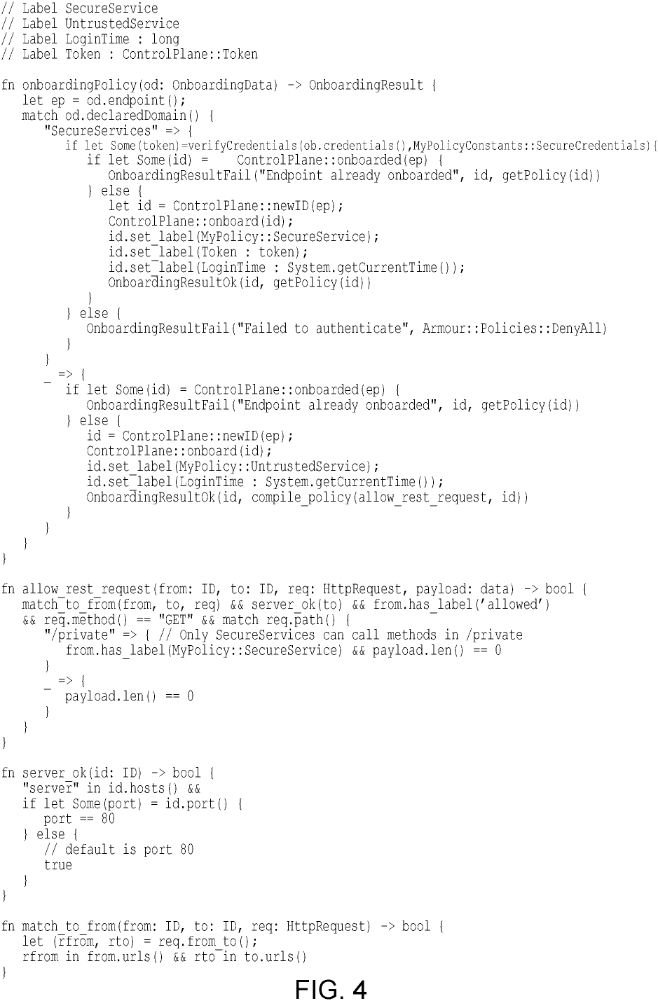

FIG. 4 shows an example of a global policy in accordance with some examples;

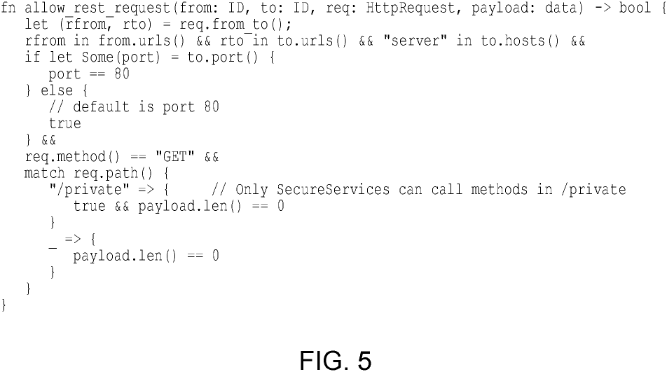

FIG. 5 shows an example of a specialised local policy in accordance with some examples;

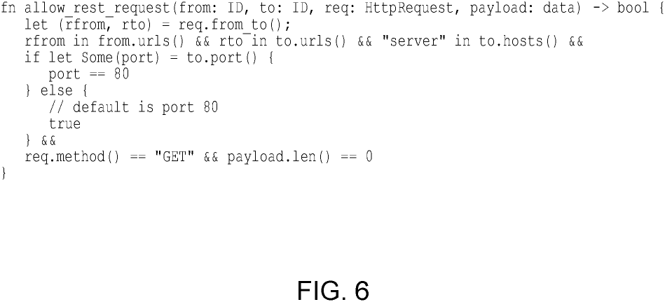

FIG. 6 shows an example of a specialised local policy in accordance with some examples;

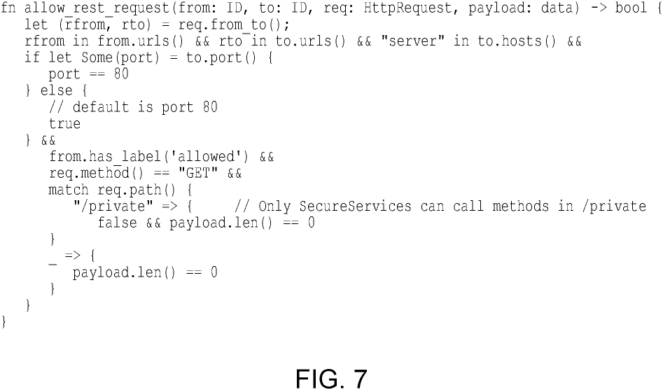

FIG. 7 shows an example of a specialised local policy in accordance with some examples;

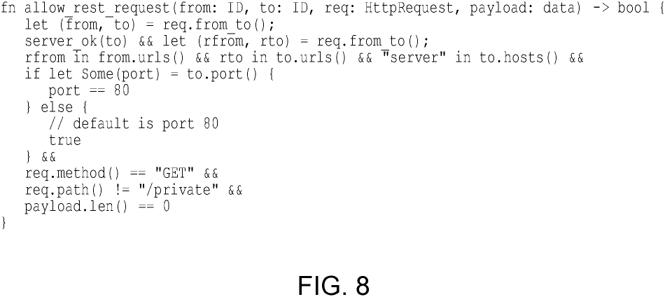

FIG. 8 shows an example of a specialised local policy in accordance with some examples; and

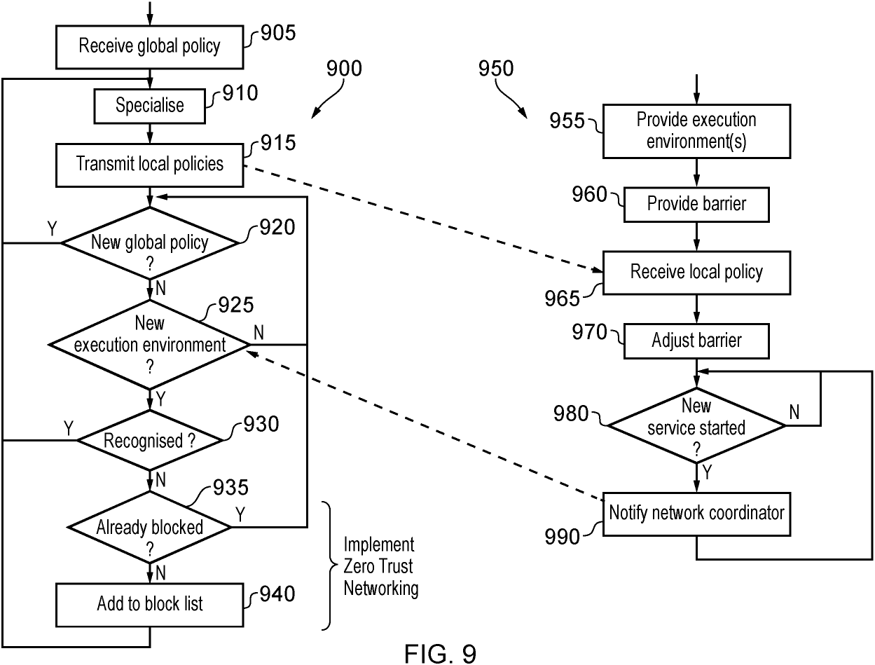

FIG. 9 illustrates, in the form of a pair of flowcharts, methods performed by a coordinator and a network node in accordance with some examples.

Before discussing the embodiments with reference to the accompanying figures, the following description of embodiments and associated advantages is provided.

In accordance with one example configuration there is provided a network node coordinator system comprising: communication circuitry to communicate, via a network, with one or more network nodes; receive circuitry configured to receive a global policy that describes a security policy to be applied across the network; policy processing circuitry to specialise the global policy and to produce, for each of the one or more network nodes, an associated local policy specific to that network node; and transmit circuitry configured to transmit, to each of the one or more network nodes, the associated local policy specific to that network node.

The coordinator system is used to coordinate network security of the one or more network nodes. In particular, receive circuitry is used to obtain a global policy. This could be uploaded or input (e.g. via a keyboard/mouse or by accessing a storage device where the policy is stored) by an operator of the network. The global policy indicates how individual elements of the networks such as the nodes, or applications running on the nodes within the network are permitted (or prohibited) from communicating over the network. This is achieved by specialising the global policy resulting in the production of one or more local policies. The term “specialisation” here means that the generated local policies are specific to the individual nodes on which the local policies exist and are not always simply copies of the entirety of the global policy. In some embodiments, the local policies do not contain parts of the global policy that are only relevant to other nodes. The process of specialisation could include compilation of the global policy (e.g. from source code into either executable code or an intermediate language) but can also include combining individual executable functions together or other techniques of converting a human-readable format into a format that can be executed on a computing device. The local policies are then transmitted to the associated nodes for implementation. Using the above technique, the network operator need not be concerned with which policies belong on which nodes. The operator also need not be concerned with the distribution of policies or, indeed, the identification of where particular services are located in the network (such as the node or nodes on which a particular service might execute). Consistency within the network is thus maintained. By the use of middleware on each of the network nodes, it is also possible for the network operator to avoid the consideration of the specific hardware used by each network node.

In some examples, the associated local policy for each network node in the one or more network nodes indicates a security policy in respect of communications between one or more execution environments that are configured to execute on that network node and the network. Each of the one or more network nodes within the network can provide execution environment(s). These execution environments can be encapsulated in such a way that the network traffic from and to those execution environments can, at least to some extent, be analysed. The traffic can therefore be assessed against a local policy that is generated using the global policy at the network coordinator system. The security policy can therefore be directed not only to the traffic for the one or more network nodes themselves, but can also be directed to the traffic to and from particular execution environments that operate on the one or more network nodes. This can be used to allow or inhibit traffic for particular applications in execution environments.

In some examples, the network node coordinator system comprises: registration circuitry to perform registration of a new execution environment that has started execution on one of the network nodes in response to a notification received by the receive circuitry, wherein in response to the registration, the policy processing circuitry specialises the global policy to reproduce, for each of the one or more network nodes, the associated local policy specific to that network node, and causes the transmit circuitry to retransmit, to each of the one or more network nodes, the associated local policy specific to that network node. Registration circuitry makes it possible to “onboard” an execution environment that is newly started by one of the nodes in the network. In particular, once a new execution environment is launched by one of the network nodes that is to be subjected to the global policy (which could be all execution environments), that network node sends a registration request regarding the execution environment to the network node coordinator system. This registration request is provided to the registration circuitry that determines whether the execution environment is known within the global policy. For instance, the global policy could name specific execution environments, could name particular applications, could identify applications according to the port used by that application, and so on. Based on the registration, the policy processing circuitry can specialise the global policy. This process can cause the local policies that were previously generated to be updated. The updated local policies can then be retransmitted to each of the one or more network nodes for implementation. This way, as the operations performed by each of the one or more nodes changes over time, the one or more nodes can adapt according to the global policy. As a simple example, the global policy may disallow all traffic other than web traffic. If existing execution environments all use HTTP, this might result in the opening of port 80 (HTTP), but the closing of all other ports. If, in due course an execution environment launches that uses HTTPS (port 443), then the local policy for the node on which that execution environment is launched might be changed during the specialisation process to open port 443. Similarly, if the ports are opened in respect of particular execution environments, then the port 443 may be opened only in respect of that execution environment that requires access to HTTPS. This modification process does not involve the network operator and the global policy need not be rewritten. Furthermore, to the extent that the local policy is rewritten, this is handled autonomously by the network node coordinator system.

In some examples, in response to the registration when the global policy omits behaviour of the new execution environment, the policy processing circuitry is configured to produce the associated local policy for at least one of the network nodes on which the execution environment is located in which traffic from the new execution environment to the network is blocked. As default, if the new execution environment is not known within the global policy, then the local policy will, as a default, disallow traffic to or from that execution environment. Note that in some situations, this may necessitate the local policy being recreated. In other situations, the local policy that has been previously generated could be such that the new execution environment is already blocked without further amendment being necessary. For instance, in the previous web-traffic example, all ports other than port 80 are initially blocked. Thus, if an unknown execution environment requests access to port 110 then no modification to the local policy is necessitated, since such traffic is already blocked.

In some examples, the global policy is written in a Domain Specific Language. In particular, the DSL could take the form of a network-based DSL. This makes it possible to more elegantly express particular concepts that are specific to a network than is possible in a general purpose language. In some examples, the DSL can be interpreted by means of a run-time infrastructure.

In some examples, the one or more network nodes are first-class entities in the global policy. In these examples, the network nodes are first-class entities and thus can be, for instance, passed as an argument, returned from a function, modified and assigned to a variable as with other entities in the programming language design. The consequence of this, it is again possible to elegantly define the security policy of the network in an efficient manner. In some examples, other entities within the network such as execution environments could also (or alternatively) be first-class entities. The use of nodes and/or environments as first-class entities is also well-suited to being used with security libraries, which saves the network operator having to write code in the DSL themselves.

In some examples, the one or more network nodes are heterogeneous. The network could therefore contain a number of different configurations of network nodes and could each have different hardware and/or software characteristics. The present technique is especially useful in such networks, since the provision of a global policy that is specialised into a number of local policies means that the network operator need not be concerned about how to implement each rule of the global policy for each different hardware configuration. The further provision of middleware on each network node for implementing the local policies means that the network operator need not be concerned with any specific configuration. Similarly, the same policy can be deployed in a number of environments (e.g. cloud, edge devices, IoT). Regardless of which environment the policy is deployed within, the global policy need not be rewritten in each case and can instead by handled by the specialisation process.

In some examples, the global policy is platform-agnostic. By being platform-agnostic, the global policy need not take into account the specific hardware characteristics of the node on which a particular policy is to be enacted. Instead, the global policy can be directed towards the desired outcome or restrictions of the security policy itself rather than dealing with how the policy is to be implemented. The implementation can be determined by at least one of the specialisation process, or middleware executing on the network node itself that implements the local policy that has been generated.

In some examples, the associated local policy of each of the network nodes is platform-agnostic. In such situations, the specialisation process itself is not concerned with the hardware or software characteristics of the particular nodes in the network. Instead, this process is left to the middleware that executes on the network nodes and implements the local policies using available hardware and software that is specific to that network node. This can lead to greater flexibility in the sense that the provider of the specific network node can provide their own middleware that is best able to implement the local policies that are received. The provider of the network node is often best placed to determine the capabilities of the node and the most appropriate techniques available for implementing local policies.

In some examples, in response to the receive circuitry receiving an updated global policy, the policy processing circuitry specialises the global policy to reproduce, for each of the one or more network nodes, the associated local policy specific to that network node, and causes the transmit circuitry to retransmit, to each of the one or more network nodes, the associated local policy specific to that network node. The global policy therefore need not be static. In particular, changes to the global policy make it possible for the nodes within the network to be updated with a revised security policy. With other techniques, the problem of changing the global security policy exacerbates the problem of a heterogeneous or complex system. In particular, if the network contains a number of heterogeneous network nodes, then a new security policy may have to be devised for each of the network nodes, which must then be provided to each of those nodes. In some previously proposed techniques, the provision of security policies within a network node can be arcane. For instance, some architectures implement security policies by the use of soft links within a file system. At the very least, implementation of a security policy in a manual manner usually necessitates uploading a number of files in specific locations within the file system of the network node. This might have to be carried out separately for each of the nodes, with different policies and/or configuration files having to be provided for each node. With different languages, configuration methods, and directives being provided for each type of network node, the problem can quickly become unmanageable. The present technique overcomes these problems by providing a coordinator system that specialises a global policy into a number of local policies that can be distributed and implemented.

In some examples, the global policy comprises one or more rules; at least some of the rules are applied to entities in the network having one or more labels; and the network node coordinator system is adapted to assign the one or more labels dynamically. Labels can be provided in order to dynamically alter the application of particular local policies over time. In particular, rules within the global policy may make reference to particular labels. For instance, a particular rule may disallow requests relating to DNS unless a particular entity making the DNS request is considered to be trusted. This could be implemented by the use of a ‘trusted’ label. The ‘trusted’ label can be assigned dynamically to an entity by (e.g.) the network node coordinator system. This could occur, for instance, after the entity has been active for a period of time, or after the behaviour of the entity has been demonstrated to be trustworthy. Such an assignment could also be made at the request or one of the network nodes. Such entities could include network nodes or execution environments that are provided by the network nodes. Other possibilities may also exist. Similarly, mechanisms may be provided in order to remove the previous assignment of a label to a device or execution environment within the network. For instance, if a particular execution environment was found to be problematic, then the network node coordinator system (possibly at the request of one of the nodes in the network) could remove the ‘trusted’ label that was provided to that execution environment.

In some examples, each of the global policy, and the associated local policy for each of the one or more network nodes, is configured to indicate at least one of: allowed traffic flows in the network and prohibited traffic flows in the network. There are a number of ways in which the security policies (provided by the global policy and/or local policies) provide security within the network. However, in these examples, the policies indicate allowed and/or prohibited traffic flows within the network. These could be provided on application basis, a device basis, a port basis, etc.

In some examples, each of the global policy, and the associated local policy for each of the one or more network nodes, is configured to indicate required security for communications. Another manner in which the global policy and/or the local policies can control network traffic is by indicating required security for communication to be permitted within the network. This could include the need for encryption for particular types of communication (e.g. from particular origins to particular destinations, for traffic of particular types, for particular devices or particular ports etc.).

In some examples, the required security for communications requires that at least one end-point of communications are to be authenticated. For instance, the security policy may dictate that a particular end point or origin point of a communication be authenticated or that a particular form of authentication be used.

In some examples, the global policy, and the associated local policy for each of the one or more network nodes, is configured to implement a Zero Trust Networking security pattern. With Zero-Trust Networking, it is assumed that all network traffic is undesirable and therefore not to be permitted until proven otherwise. This can result in a configuration in which, by default, traffic is not permitted. Furthermore, such a policy typically provides the fewest privileges necessary in order to enable desirable traffic to be transmitted. For instance, if DNS requests are permitted, then security policy may only permit traffic that originates from devices allowed to make DNS requests, to devices that are able to answer DNS requests, where the traffic looks like a DNS request, using DNS ports and so on. In some embodiments, Zero Trust Networking is built into the language of the global policy. For instance, as a library. Consequently, for such implementations, it is not necessary for the network operator to go to considerable lengths in order to program this into the global policy.

In accordance with another example configuration there is provided a network node comprising: network interface circuitry configured to enable communication via a network; receive circuitry configured to receive a local policy from a network node coordinator system; barrier circuitry configured to restrict use of the network interface circuitry based on the local policy; and processing circuitry configured to provide one or more encapsulated execution environments, wherein network traffic from each of the one or more encapsulated execution environments is restricted to flowing via the barrier circuitry.

In the network node, the network interface circuitry receives and transmits the network traffic that is to be subject to the global and local policies. Data that is to be subject to those policies is provided to the barrier circuitry (which could, for instance take the form of a CPU) so that the traffic can be inspected. Here, the traffic is evaluated against the local policy to determine whether the traffic should be allowed or refused. Processing circuitry (which could take the form of a different or the same CPU) provides one or more encapsulated execution environments in which particular applications can be made to run. Traffic to and from the encapsulated execution environments is subject to evaluation against the global and local policies via the barrier circuitry. Thus, the global policies that are specialised into local policies are executed by the barrier circuitry. The barrier circuitry can make use of techniques specific to the hardware and software of the specific network node in order to implement the local policy. For instance, a Unix-based network node might implement the local policy using iptables. Other software and/or hardware might be used by a Windows-based server. In some situations, the nature of the policy might make it possible to use more application-specific solutions. For instance, an HTTP or HTTPS based restriction could be implemented by the means of an nginx proxy. The network operator therefore need not be concerned with the specifics of the hardware and/or software implementation provided for a specific node.

Particular embodiments will now be described with reference to the figures.

FIG. 1 illustrates a system 100 that contains a number of network nodes 130a, 130b, 130c, 130d, which communicate with each other via a network 150. The network 150 also provides access to a cloud infrastructure 140. Within this network 150, it is desirable to apply a security policy. This is achieved by providing a global policy 120 to a coordinator 110, which also has access to the network 150. The coordinator 110 uses the global policy 120 and specialises it in order to produce one or more local policies 160a, 160b, 160c, 160d. Each of the local policies 160a, 160b, 160c, 160d is specialised for one of the network nodes 130a, 130b, 130c, 130d and contains the code necessary for that node (and any services operated by that node) to operate according to the global policy 120. However, in these embodiments, the local policies do not contain policies for anything unrelated to each node. These local policies 160a, 160b, 160c, 160d are then transmitted to each of the network nodes 130a, 130b, 130c, 130d for implementation. For instance, a first local policy 160a, which is generated for network node A 130a is generated from the global policy 120 via the coordinator 110. The local policy 160a is then transmitted to the node A 130a for implementation. Similarly, a second local policy 160a is generated from the same global policy 120 by the coordinator 110 and transmitted to network node B 130b for implementation. A third local policy 160c is generated from the same global policy 120 by the coordinator 110 and transmitted to network node C 130c for implementation. Meanwhile, a fourth local policy 160d is generated for network node D 130d from the same global policy 120 and transmitted to network node D 130d for implementation.

The network nodes 130a, 130b, 130c, 130d are heterogeneous. In other words, the hardware and/or software configurations are not the same for each of the network nodes 130a, 130b, 130c, 130d. In this particular example, each of the network nodes 130a, 130b, 130c, 130d has a different hardware characteristic. For instance, network node A 130a features a single CPU 170a. Network node B 130b contains a pair of CPUs 170b. Network, node C 130c contains a GPU 190c and a CPU 170c. Network node D 130d contains three CPUs 170d. The purpose of each of the network nodes 130a, 130b, 130c, 130d could also differ. For instance, such nodes could be high-end nodes (such as one could find in the cloud), edge-nodes, and perhaps end-user devices and IoT devices.

In this example, each of the network nodes 130a, 130b, 130c, 130d executes a number of execution environments. Execution environments permit the encapsulation of the processing and network operations performed by a particular application or service. The number of execution environments that are executed by each network node differs, can change over time, and might dependent on the hardware characteristics of that node. In this example, network node A 130a executes execution environment 180a. Network node B 130b executes an execution environment 5 180b. Network node C 130c executes an execution environments 2 and 3 180c. A network node D 130d executes and execution environment 9 180d.

The global policy 120 can address any of the entities used within the system 100. This includes, but is not limited to, the execution environments 180a, 180b, 180c, 180d, the network nodes 130a, 130b, 130c, 130d, specific forms of traffic generated by either of these (e.g. based on a particular application protocol, particular ports, origins and destinations, types of security or authentication used) and so on. Furthermore, the global policy 120 could also be agnostic to any particular service, instead specifying policies in respect of any service or node having certain characteristics. Global policy 120 illustrated in FIG. 1 shows a number of restrictions in place. Firstly, any form of traffic from a device that is labelled as ‘trusted’ can transmit data to network node A 130a. The process of labelling can be dynamically applied by the coordinator 110, e.g. during an onboarding process that occurs when a service starts up on a node. This makes it possible for labels and for network rules to be changed and adapted over time. A second rule implemented by the global policy 120, is that any form of traffic can be transmitted from network node C 130c to any other node provided that other node is authenticated. This provides an example of security restriction. Such authentication could be achieved through application sessions, for instance. A third rule in the global policy 120 relates to the publication of data by network node B 130b to the cloud 140. In this case, the presence of a cross indicates that such traffic is not permitted. In other words, network node B 130b is not permitted to publish any data to the cloud 140. The fourth rule permits node B 130b to request data from the cloud 140. In this case, contrary to the previous rule, the presence of a tick indicates that such traffic is permitted. The fifth rule permits network node A 130a to transmit any data to network node C 130c. Finally, the sixth rule permits execution environment 9 180d that executes on network node D 130d to transmit any data to network node A 130a.

The process of specialisation performed by the coordinator 110 takes the global policy 120 and uses it to produce one or more local policies 160a, 160b, 160c, 160d. The local policies 160a, 160b, 160c, 160d are each specialised to the network node 130a, 130b, 130c, 130d on which that local policy will execute. In this case, the specialisation process involves the extraction of those of the rules in the global policy 120 that apply to the particular network node and/or its currently executing services. For example, the local policy 160a that is generated in respect of network node A 130a permits traffic to be transmitted from network node A 130a to network node C 130c. Furthermore, the local policy 160a also permits any incoming traffic that is from a source that is labelled as trusted. This local policy 160a does not, however, relate to any of the other rules in the global policy 120, which instead involve other network nodes. Similarly, the local policy 160a which is generated for network node B 130b prevents any publication of data from network node B 130b to the cloud. However, it permits requests to be transmitted to the cloud 140. The local policy 160c generated for network node C 130c permits the transmission of any data to any node in the network that has been authenticated. Finally, the local policy 160d that is generated for network node D 130d permits traffic to be generated from execution environment 9 180d to network node C 130c.

In this way, it can be seen that the local policies that are generated are specific to each of the network nodes 130a, 130b, 130c, 130d. The operator of the system 100 need not generate these local policies but can instead consider a single global policy that may affect one, subsets, or all of the network nodes 130a, 130b, 130c, 130d. The global policy 120 can be provided via a Domain Specific Language (DSL) which makes it possible for the operator to more easily write the global policy 120. Furthermore, the process of specialising the local policies can result in local policies 160a, 160b, 160c, 160d, which are hardware-agnostic. This can be achieved by the use of middleware executing on each of the network nodes 130a, 130b, 130c, 130d, which are able to implement the local policy having regard to the hardware and software capabilities of the node on which it executes. Consequently, the network operator need not be concerned with the exact configuration of each of the nodes 130a, 130b, 130c, 130d, or even (necessarily) which services run on each node and need not provide specialised local policies for each possible hardware configuration of network node in the system 100.

FIG. 2 illustrates an example of communication that occurs between the network node coordinator system 110, and network nodes 130a, 130b. The network node coordinator system 110 includes communication circuitry 200 which is able to communicate with the network 150. In particular, the communication circuitry 200 makes it possible to communicate with each of the network nodes 130a, 130b via the network 150. The coordinator system 110 also includes receive circuitry 220 for receiving messages that are provided to the network node coordinator system 110 via the communication circuitry 200. The communication circuitry 200 and the receive circuitry 220 are also responsible, in this example, for receiving the global policy 120 provided by a network operator. In other embodiments, the global policy 120 could be provided directly to the coordinator system 110 via other input forms such as keyboard, or by direct access to storage of the network node coordinator system 110. Policy processing circuitry 230 is used to process the global policy 120. This results in the generation of one or more local policies. These are transmitted via the communication circuitry 200 using transmit circuitry 210. The network node coordinator system 110 also includes registration circuitry 240. In this example, the registration circuitry 240 forms part of the policy processing circuitry 230. Registration circuitry 240 is responsible for handling the onboarding of execution environments on network nodes 130a, 130b that begin execution. In particular, by being notified of the existence of new execution environments by the relevant network node, the policy processing circuitry 230 can determine whether updates to the local policies are necessitated. If so, the global policy 120 can be re-evaluated, and updated local policies can be retransmitted using the transmission circuitry 210 and the communication circuitry 200. The local policies that are transmitted by the network node coordinator system 110 are provided to barrier circuitry 250a, 250b on each of the network nodes 130a, 130b. The barrier circuitry 250a, 250b is used to provide a barrier 270a, 270b. The specific form of barrier 270a, 270b that is provided is dependent on the hardware and/or software configurations of the network node. The execution environment 130a, 130b that executes on processing circuitry 170a, 170b on the network nodes 130a, 130b generates network traffic that is forced through the barrier 270a, 270b. Consequently, by configuring the barrier 270a, 270b via the barrier circuitry 250a, 250b, the local policy can be implemented such that the execution environment obeys the local policies that themselves reflect the global policy 120 provided by the network operator. In this way, the barrier circuitry acts a middleware component for providing a barrier 270a, 270b.

FIG. 3 illustrates an example of a network node 130 as may be implemented using a Unix-like system. In this example, the barrier circuitry could itself be a CPU that is provided for other purposes. The barrier circuitry 250 configures the barrier in the form of iptables 270 using a local policy that has been received. iptables is a piece of software designed for Unix in order to provide a software-based firewall. The CPU (which in this example acts as the barrier circuitry 250) also provides a number of execution environments. These are implemented using docker 310. Each docker instance 310 provides a virtual network 300 in which an application/service container 180 in the form of an execution environment is provided. In this way, each execution environment is encapsulated and cannot interfere with any other execution environment. Furthermore, the provision of a virtual network 300 makes it possible for all of the network traffic generated by the application running in the execution environment 180 to be encapsulated and forced to pass through iptables 270, where it can be evaluated against the local policy as configured by the barrier circuitry 250. Incoming traffic received at the Ethernet interface 260 is also passed through iptables 270 and then transmitted to the relevant container 180 if it is allowed by the local policy. This can be determined either by transmitting the traffic to the barrier circuitry 250 for evaluation against the local policy, or by implementing iptables 270 so that iptables 270 mimics the local policy.

FIG. 4 illustrates an example of a global policy using a Domain Specific Language (DSL). The DSL defines a number of labels that can be applied to entities in the network - SecureService, UntrustedService, LoginTime, and Token. The LoginTime and Token labels are labels that have a particular value associated with them - namely a time at which the entity was onboarded and a global token/identifier for the particular entity respectively.

The example of FIG. 4 provides a first function - onboardingPolicy, which defines a policy for the onboarding of new execution environments (also referred to as services). It receives OnboardingData and returns an OnboardingResult containing an identity for the network and its associated policy. The variable, ‘ep’ refers to an endpoint (e.g. a node) on which the new service being onboarded is present. The function then looks at what the service is claiming to be.

If the new service is claiming to be a SecureService, the function verifies the credentials provided for the new service. These could include the use of digital signatures and/or attestation to determine that the new service is what it claims to be. If the credentials cannot be verified, the onboarding process fails. Otherwise, the function determines whether the service has already been onboarded. If so, the onboarding process fails. Otherwise, the onboarding process is performed, which includes assigning labels to the entity - the SecureService label, the Token label (together with the identity of the service), and the LoginTime (together with the current system time).

If the new service is claiming to be something other than a SecureService, then again, the function determines whether onboarding has already been performed for this service and fails if it has been performed. If onboarding has not been performed then onboarding is performed - the label UntrustedService is added to the service, and the Token and LoginTime labels are added as previously described. Note that in this situation, the credentials are not checked because the service is not treated as a SecureService. This may have consequences elsewhere in the global policy regarding what the service is/is not permitted to do.

The example of FIG. 4 also provides a rule in the form of allow rest request, which is a function to determine whether a Representational State Transfer (REST) request is permitted to take place or not. The function takes, as inputs, an origin of the request (from), a destination of the request (to), the request itself that is being made (req), and a payload of the request (data). It returns a Boolean (true/false) indicating whether the request is permitted or not. Note that this function provides an example of network entities being used as first-class entities. In particular, the source/origin and destinations of the request are passed as parameters in the function. Note that the function does not necessitate whether the source/origin or destination of the request is a particular node or a service running on the node, and thus can cover either possibility. It is therefore possible for the function to be implemented efficiently.

In short, the function determines whether the ‘from’ and ‘to’ variables are matched (see below), that the ‘to’ entity is okay (see below), that the ‘from’ entity has the label “allowed” and that the HTTP request format is “GET” (as opposed to “POST”). Note that no specific definition of how the “allowed” label is assigned is provided here. This could be used to indicate that traffic of any kind of permitted, or could be used specifically for REST requests to indicate that REST requests are permitted. Other possibilities could also exist. The function then considers the path that is accessed by the HTTP request. If the path being accessed is “/private” then the requesting entity must have the SecureService label as previously discussed. Furthermore, the payload size must be zero. If these requirements are not met then the request will not be allowed. If the path being accessed is anything other than “/private” then the payload size must simply be zero.

The server_ok function is used by the allow rest request function to determine whether the ‘to’ entity is okay. This function requires that the specified entity has a name of “server”, and that the port being used is port 80 (for HTTP). In this way, the request headers can be used to control traffic.

The match_to_from function is also used by the allow_rest_request function to match the ‘from’ and ‘to’ entities in the request. In particular, the function determines whether the ‘from’ and ‘to’ entities that are listed in the request are the ‘from’ and ‘to’ entities provided for the allow rest request function.

FIG. 4 thus illustrates a global policy that defines onboarding a new service and of determining whether particular traffic is permitted or not.

Various techniques such as code inlining, symbolic and partial evaluation, common sub-expression elimination, and dead-code elimination techniques, as well as Boolean and arithmetic simplification can be used to convert the global policy into local policies.

FIG. 5 illustrates a result of specialising the allow _rest_ request function, achieved by inlining the match_to _from function and the server_ok function. If the local policy is being generated in respect of a service that is already labelled as a SecureService, then partial evaluation can be used - the specialised code need not handle the situation in which this service is not labelled as SecureService.

FIG. 6 illustrates a result of performing Boolean simplification (true && X ==> X) as well as dead-code elimination (the removal of unnecessary conditions). The example illustrated in FIG. 6 therefore acts as a specialised local policy for any SecureService.

FIG. 7 shows an example of how a similar process can be performed in respect of the services that are labelled as UntrustedService. In the example of FIG. 7, the initial allow rest request function that was shown in FIG. 4 has had inlining as well as partial evaluation performed (assuming that the service is an UntrustedService).

FIG. 8 then illustrates the result of applying Boolean simplification and dead-code elimination to produce a specialised local policy that can be provided in respect of each UntrustedService in the network.

FIG. 9 provides a pair of flow charts 900, 950 that illustrate the behaviour of the coordinator 110 and a network node 130 respectively. At a step 905, a global policy is received by the coordinator 110. This could be directly provided via an input mechanism on the coordinator 110, could be provided via (for instance) shared storage circuitry that the coordinator 110 has access to, or could be uploaded via another node on the network 150 for instance. The global policy is then specialised in step 910 to produce a number of local policies 160. These local policies can be generated using the previously demonstrated techniques so that they are specific to each node and/or service that can be found within the network. The process of generating the local policies could also involve compilation in the traditional sense so that the local policy can be directly executed by barrier circuitry 250. At a step 915, the local policies are transmitted to the network nodes 130.

Separately, the network nodes provide, at step 955, one or more execution environments, e.g. for executing services. The nodes 130 also provide a barrier 270 via barrier circuitry 250. Such a barrier can be implemented using software such as iptables for instance. The local policies that were transmitted at step 915 are received by the network nodes 130 at step 965. The barrier 270 of each node is then adjusted as appropriate based on the received local policies at step 970. Of course, whether the barrier directly implements the local policy or whether the barrier simply enables the inspection of traffic to assess against the local policy will be dependent on the precise implementation of the network node 130. At step 980, it is determined whether a new service (e.g. execution environment) is started on the node. If not, the process loops until such a service is started. If so, then the process proceeds to step 990 where the network coordinator is informed about the new service and is provided with any necessary/requested information to assess whether re-evaluation of the global policy is warranted.

Returning to the operation of the coordinator 110, step 920 determines whether a new global policy has bene provided. If so, the process returns to step 910 for specialising of the local policies. Otherwise, at step 925, it is determined whether a new execution environment/service has been started on one of the nodes (e.g. via step 990). This can be achieved by communication of a registration message sent by the relevant network node 130 to the coordinator 110. If not, then the process returns to step 920. In other words, these checks continue. At step 925, the onboarding process for the new execution environment (e.g. service) begins, and it is firstly determined whether the service is recognised. If so, then the process returns to step 910 where specialisation of the global policy occurs. This may lead to the generation of one or more local policies that are then transmitted (at step 915) to the new node.

At step 935, it is determined whether the new service is already blocked by the global policy. For instance, if the global policy implements Zero Trust Networking, then the service is likely already blocked. The process then returns to step 920. Otherwise, in this example, the service is actively blocked at step 940. This could occur, for instance, by labelling the services as an UntrustedService (as previously seen), by removal of any ‘allowed’ label, or even by the addition of an ‘untrusted’ or ‘blocked’ label, for instance. In any event, having indicated that the service is to be blocked, the process returns to step 910 for specialisation of the global policy so that the newly added service can be blocked.

Consequently, on receiving such a global policy 120, the coordinator 110 can determine policies for, in this case, services labelled as SecureService or UntrustedService, generate specialised local policies for each of these types of service and then distribute the specialised local policies to the relevant nodes. At each of the relevant nodes, the local policy can be interpreted by the barrier circuitry 250 in order to provide a barrier 270 that implements the local policy and through which network traffic from the services passes. Note that in the above examples, the network operator need not be concerned with the number of nodes, the type of the nodes, the hardware/software configuration of the nodes, and need not be concerned with new services or nodes joining or leaving the network. The network operator also need not be concerned with distributing the configurations. The local policies that are produces are specific to each of the nodes and thus need not contain data that is irrelevant to a particular node - thereby increasing efficiency. It will be appreciated that the above techniques can be applied to a number of different scenarios - including a number of different possible labels.

In the present application, the words “configured to...” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. A network node coordinator system comprising:
communication circuitry to communicate, via a network, with one or more network nodes;
receive circuitry configured to receive a global policy that describes a security policy to be applied across the network;
policy processing circuitry to specialise the global policy and to produce, for each of the one or more network nodes, an associated local policy specific to that network node; and
transmit circuitry configured to transmit, to each of the one or more network nodes, the associated local policy specific to that network node.

2. The network node coordinator system according to claim 1, wherein the associated local policy for each network node in the one or more network nodes indicates a security policy in respect of communications between one or more execution environments that are configured to execute on that network node and the network.

3. The network node coordinator system according to claim 1, comprising:
registration circuitry to perform registration of a new execution environment that has started execution on one of the network nodes in response to a notification received by the receive circuitry, wherein in response to the registration, the policy processing circuitry specialises the global policy to reproduce, for each of the one or more network nodes, the associated local policy specific to that network node, and causes the transmit circuitry to retransmit, to each of the one or more network nodes, the associated local policy specific to that network node.

4. The network node coordinator system according to claim 3, wherein in response to the registration when the global policy omits behaviour of the new execution environment, the policy processing circuitry is configured to produce the associated local policy for at least one of the network nodes on which the execution environment is located in which traffic from the new execution environment to the network is blocked.

5. The network node coordinator system according to claim 1, wherein the global policy is written in a Domain Specific Language.

6. The network node coordinator system according to claim 1, wherein the one or more network nodes are first-class entities in the global policy.

7. The network node coordinator system according to claim 1, wherein the one or more network nodes are heterogeneous.

8. The network node coordinator system according to claim 1, wherein the global policy is platform-agnostic.

9. The network node coordinator system according to claim 1, wherein the associated local policy of each of the network nodes is platform-agnostic.

10. The network node coordinator system according to claim 1, wherein in response to the receive circuitry receiving an updated global policy, the policy processing circuitry specialises the global policy to reproduce, for each of the one or more network nodes, the associated local policy specific to that network node, and causes the transmit circuitry to retransmit, to each of the one or more network nodes, the associated local policy specific to that network node.

11. The network node coordinator system according to claim 1, wherein the global policy comprises one or more rules;
at least some of the rules are applied to entities in the network having one or more labels; and
the network node coordinator system is adapted to assign the one or more labels dynamically.

12. The network node coordinator system according to claim 1, wherein each of the global policy, and the associated local policy for each of the one or more network nodes, is configured to indicate at least one of:
allowed traffic flows in the network and prohibited traffic flows in the network.

13. The network node coordinator system according to claim 1, wherein each of the global policy, and the associated local policy for each of the one or more network nodes, is configured to indicate required security for communications.

14. The network node coordinator system according to claim 13, wherein the required security for communications requires that at least one end-point of communications are to be authenticated.

15. The network node coordinator system according to claim 1, wherein each of:
the global policy, and the associated local policy for each of the one or more network nodes, is configured to implement a Zero Trust Networking security pattern.

16. A method comprising:
communicating, via a network, with one or more network nodes;
receiving a global policy that describes a security policy to be applied across the network; and
specialising the global policy to produce, for each of the one or more network nodes, an associated local policy specific to that network node; and transmitting, to each of the one or more network nodes, the associated local policy specific to that network node.

17. A network node comprising:
network interface circuitry configured to enable communication via a network;
receive circuitry configured to receive a local policy from a network node coordinator system;
barrier circuitry configured to restrict use of the network interface circuitry based on the local policy; and
processing circuitry configured to provide one or more encapsulated execution environments, wherein network traffic from each of the one or more encapsulated execution environments is restricted to flowing via the barrier circuitry.

18. A method comprising:
receiving a local policy from a network node coordinator system;
providing a barrier that restricts use of network interface circuitry based on the local policy; and
providing one or more encapsulated execution environments, wherein network traffic from each of the one or more encapsulated execution environments is restricted to flowing via the barrier.
